(19) United States
(12) Patent Application Publication
(10) Pub. No.: US 2026/0311515 A1
(43) Pub. Date: Oct. 8, 2026

(54) FACE FORGERY DETECTION METHOD AND SYSTEM BASED ON GRAPH CONVOLUTIONAL NEURAL NETWORK

(71) Applicant: NANJING UNIVERSITY OF POSTS AND TELECOMMUNICATIONS, Nanjing (CN)

(72) Inventors: Lihua WANG, Nanjing (CN); Weidan YAN, Nanjing (CN); Dengyin ZHANG, Nanjing (CN)

(21) Appl. No.: 19/210,423

(22) Filed: May 16, 2025

Related U.S. Application Data
(63) Continuation of application No. PCT/CN2025/089521, filed on Apr. 17, 2025.

(30) Foreign Application Priority Data
Apr. 7, 2025 (CN) 202510423206.3

(51) Int. Cl. G06V 40/40; G06V 10/62; G06V 10/764; G06V 10/774; G06V 10/776; G06V 10/82; G06V 20/00; G06V 20/40; G06V 40/16

(52) U.S. Cl. CPC G06V 40/40; G06V 10/62; G06V 10/764; G06V 10/774; G06V 10/776; G06V 10/82; G06V 20/40; G06V 20/95; G06V 40/171; G06V 40/172

(57) ABSTRACT

The present application proposes a face forgery detection method based on a graph convolutional neural network, which includes: obtaining a to-be-detected face video; inputting the to-be-detected face video into a trained detection model to obtain a judgment result on whether the video is forged; wherein the detection model includes: an encoder, for generating features of each frame of the to-be-detected face video; a spatiotemporal composite graph construction module, for constructing a spatiotemporal composite graph composed of the spatial graph and the temporal graph based on the features of each frame of the input video; a spatiotemporal composite graph convolution module, for performing feature learning based on the spatiotemporal composite graph to obtain classification features; and a classifier, for predicting an authenticity result of the to-be-detected face video based on the classification features.

### CROSS-REFERENCE TO RELATED APPLICATIONS

This application is a continuation of International Application No. PCT/CN2025/089521, filed on Apr. 17, 2025, which is based upon and claims priority to Chinese Patent Application No. 202510423206.3, filed on Apr. 7, 2025, the entire disclosures of which are incorporated herein by reference.

### TECHNICAL FIELD

The present application belongs to the technical field of face forgery detection, and specifically relates to a face forgery detection method and system based on a graph convolutional neural network.

### BACKGROUND

With the rapid development of multimedia technology, the number of videos with human faces as the theme is increasing day by day, and face-related technologies have been widely applied in fields such as social security (such as face recognition) and audio-visual entertainment (such as face enhancement). However, along with the progress of advanced technologies, the phenomenon of maliciously using these technologies for face forgery has become increasingly rampant. Through face deepfake technologies (such as generative adversarial networks GAN, diffusion models, etc.), face swapping, attribute editing, and synthesis of face images and videos can be achieved, thus creating extremely authenticity false face images and videos. These forged contents can often be indistinguishable from the authentic ones and spread rapidly on social media platforms, thereby posing a serious threat to personal privacy, public safety, and social trust. For example, fake celebrity videos may be configured to mislead public opinion and spread fake information; forged identity images may be used for fraudulent activities, harming the interests of others. It can be seen that the illegal use of face forgery technology brings huge hidden dangers to personal property and social harmony and stability.

Thus, face forgery detection technology has emerged, aiming to distinguish the authenticity of face images and videos. Although existing face forgery detection methods can, to a certain extent, identify some forged samples, in the face of constantly updated and iterated forgery technologies, traditional methods have gradually revealed their limitations. In addition, detection methods based on manual feature extraction are difficult to adapt to complex and changeable forgery patterns. With the rise of deep learning models, existing face forgery detection models based on deep learning still have deficiencies in detection accuracy and generalization ability due to the lack of effective mining of the complex structure and semantic information of face images.

### SUMMARY

The object of the present application is to overcome the deficiencies in the related work and provide a face forgery detection method and system based on a graph convolutional neural network. Starting from the requirements of spatiotemporal consistency of face videos, a spatiotemporal composite graph composed of the spatial graph and the temporal graph is constructed to achieve efficient, accurate face forgery detection with strong generalization ability.

The present application provides the following technical solutions:

In a first aspect, there is provided a face forgery detection method based on a graph convolutional neural network, which includes:
obtaining a to-be-detected face video;
inputting the to-be-detected face video into a trained detection model to obtain a judgment result on whether the video is forged;
wherein the detection model comprises:
an encoder, for generating features of each frame of the to-be-detected face video;
a spatiotemporal composite graph construction module, for constructing a spatiotemporal composite graph composed of a spatial graph and a temporal graph based on the features of each frame of the video;
a spatiotemporal composite graph convolution module, for performing feature learning based on the spatiotemporal composite graph to obtain classification features; and
a classifier, for predicting an authenticity result of the to-be-detected face video based on the classification features.

In one embodiment, the encoder includes a plurality of convolutional units and a plurality of downsampling units, and the plurality of convolutional units and the plurality of downsampling units are alternately connected in series.

In one embodiment, the spatiotemporal composite graph construction module includes a temporal graph construction unit and a spatial graph construction unit;
constructing the spatiotemporal composite graph based on the features of each frame of the image includes:
inputting f∈{T, c, h, w} into the spatiotemporal composite graph construction module, where f represents a feature vector obtained after being processed by an encoder, T represents a number of video frames, c represents a basic channel number of the features, h represents a feature height, and w represents a feature width;
the temporal graph construction unit obtains a feature vector fₜ∈{T, c×h×w} with the number T of video frames as a first dimension through a feature recombination method, and then obtains a temporal graph Gt, the temporal graph Gt contains the features of each frame corresponding to T nodes with a feature size c×h×w;
the spatial graph construction unit obtains a feature vector fₛ∈{T×h×w, c} with a total number of all positions T×h×w in each frame of the image as the first dimension through the feature recombination method, and then obtains a spatial graph Gs, the spatial graph Gs contains region features of h×w face components in each frame of the image corresponding to T×h×w nodes with a feature size c.

In one embodiment, the spatiotemporal composite graph convolution module comprises a plurality of spatial graph convolution blocks and a plurality of spatiotemporal convolution blocks, and the plurality of spatial graph convolution blocks and the plurality of spatiotemporal convolution blocks are alternately connected in series; and
each spatial graph convolution block is configured to mine spatial features of an input spatial graph, and each spatiotemporal convolution block is configured to mine temporal features of an input temporal graph.

In one embodiment, each of each spatial graph convolution block and each temporal graph convolution block comprise three graph convolution layers, three graph normalization layers and two activation layers, and three graph convolution layers, three graph normalization layers and two activation layers are alternately connected in series;
each graph convolution layer is configured to extract features from graph data by aggregating feature information of the nodes and neighbors of the nodes, capture a local structure and relationship information between the nodes in the graph, and provide a deep feature representation;
a function formula adopted by each graph convolution layer is as follows:

$${H}^{l + 1} = ∅ ( {\tilde{D}}^{- \frac{1}{2}} \tilde{A} {\tilde{D}}^{- \frac{1}{2}} {H}^{l} {W}^{l} ) ;$$

where H^{l} and H^{l+1} represent node feature matrices of lth and l+1th layers, Ã represents an adjacency matrix of the graph, \tilde{D} represents a degree matrix of Ã, WI represents a learnable weight of the lth layer, and ∅ represents an activation function;
each graph normalization layer is configured to adjust a distribution of the data to a preset range, and a function formula adopted by each graph normalization layer is as follows:

$${\tilde{h}}_{i} = \frac{{h}_{i} - {µ}_{i}}{\sqrt{{σ}_{i}^{2} + ε}} ;$$

where \tilde{h}ᵢ represents a feature vector of a node i after normalization, hi represents a feature vector of the node i, μᵢ represents a mean value of all feature dimensions of the node i,

$${σ}_{i}^{2}$$

represents a variance of all feature dimensions of the node i, and ε represents a constant to avoid a denominator being zero;
the activation layer is configured to enhance an expressive ability of a model, and the activation function adopted by the activation layer includes ReLU.

In one embodiment, the classifier includes a fully connected layer, an input size of the fully connected layer is a size of the classification feature, and an output size of the fully connected layer is 2, which respectively represent a probability of the to-be-detected face video being authentic and forged.

In one embodiment, a training method of the detection model comprises:
obtaining a training set, where the training set includes authentic face video data and face video data generated by forgery technology, and a corresponding label;
the label takes values of 0 and 1, 0 represents real samples, and 1 represents fake samples;
inputting the real face video data and the face video data generated by deepfake technology into the pre-constructed detection model to obtain a model prediction result;
calculating a cross-entropy loss function according to the model prediction result and the corresponding label;
based on the Adam optimizer, for each training batch, using forward propagation to find the cross-entropy loss function, then using backpropagation to find partial derivatives of each weight parameter, and using a gradient descent method to update the weight parameter, repeating this step until the cross-entropy loss function reaches a minimum to obtain the trained detection model.

In one embodiment, obtaining the training set includes downloading a public dataset and constructing a private dataset;
the public dataset includes FaceForensics++ and DeepFake Detection Challenge;
constructing the private dataset includes:
obtaining face videos from video websites or collecting face videos;
detecting faces using a Dlib tool from the face videos;
aligning the faces using affine transformation;
cropping face regions with a fixed margin set; and
scaling cropped face images to a fixed pixel size.

In one embodiment, an expression of the cross-entropy loss function is as follows:

$$L ( y , \hat{y} ) = - ( y log \hat{y} + ( 1 - y ) log ( 1 - \hat{y} ) ) ;$$

where y represents the corresponding label, and y represents the model prediction result.

In a second aspect, there is provided a face forgery detection system based on a graph convolutional neural network, which includes:
a data acquisition module, for obtaining a to-be-detected face video;
a detection module, for inputting the to-be-detected face video into a trained detection model to obtain a judgment result on whether the video is forged;
where the detection model includes:
an encoder, for generating features of each frame of an image in the to-be-detected face video;
a spatiotemporal composite graph construction module, for constructing a spatiotemporal composite graph composed of the spatial graph and the temporal graph based on the features of each frame of the input video;
a spatiotemporal composite graph convolution module, for performing feature learning based on the spatiotemporal composite graph to obtain classification features; and
a classifier, for predicting an authenticity result of the to-be-detected face video based on the classification features.

Compared with the related work, the beneficial effects of the present application are as follows:
the face forgery detection method and system based on the graph convolutional neural network provided by the present application, firstly, the encoder of the detection model, generates features of each frame of the to-be-detected face video for authenticity according to the face video; then, based on the spatiotemporal composite graph construction module, starts from the requirements of spatiotemporal consistency of the face video, takes advantage of the control of forged details by spatial features and the requirements for the temporal coherence by features between frames to construct a spatiotemporal composite graph composed of the spatial graph and the temporal graph; secondly, based on the spatiotemporal composite graph convolution module, obtains classification features through feature learning according to the spatiotemporal composite graph, and fully considers the interaction between the spatial graph and the temporal graph, and uses graph convolution technology to achieve efficient face forgery detection. While ensuring the lightness of the model, high detection efficiency, detection accuracy and strong generalization ability can be achieved.

### BRIEF DESCRIPTION OF THE DRAWINGS

FIG. 1 is a structural schematic diagram of the face forgery detection method based on a graph convolutional neural network in an embodiment of the present application.

FIG. 2 is a structural schematic diagram of the detection model in an embodiment of the present application.

FIG. 3 is a structural schematic diagram of a spatiotemporal composite graph construction module in an embodiment of the present application.

FIG. 4 is a structural schematic diagram of the spatiotemporal composite graph convolution module in an embodiment of the present application.

FIG. 5 is a structural schematic diagram of a spatial graph convolution block and the spatiotemporal convolution block in an embodiment of the present application.

### DETAILED DESCRIPTION OF THE EMBODIMENTS

The present application will be further described below in conjunction with the accompanying drawings. The following embodiments are only configured to more clearly illustrate the technical solutions of the present application, and shall not be configured to limit the protection scope of the present application.

The term “and/or” is merely used to describe the associative relationship of associated objects, indicating that there can be three relationships. For example, A and/or B can mean: A exists alone, A and B exist simultaneously, and B exists alone, these three situations. In addition, the character “/” generally indicates that the associated objects before and after have an “or” relationship.

### The First Embodiment

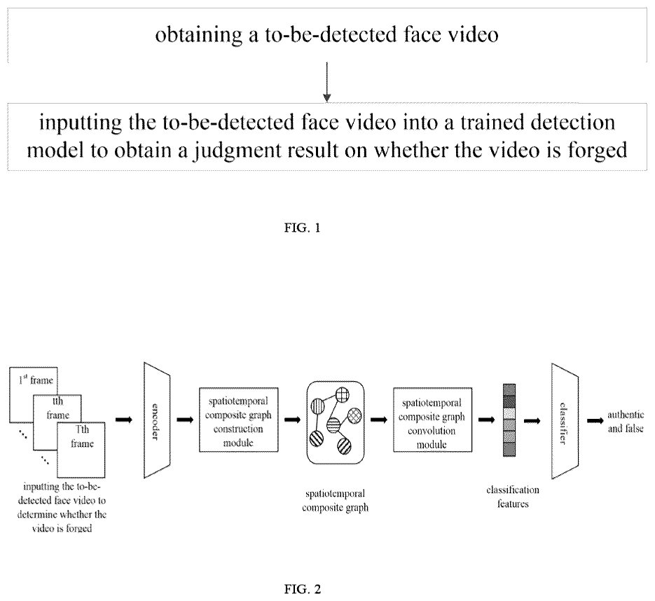

As shown in FIG. 1, the present application provides a face forgery detection method based on a graph convolutional neural network, which includes:

Step 1, obtaining a to-be-detected face video;

Step 2, inputting the to-be-detected face video into a trained detection model to obtain a judgment result on whether the video is forged.

As shown in FIG. 2, the detection model includes:
an encoder, for generating features of each frame of an image in the to-be-detected face video;
a spatiotemporal composite graph construction module, for constructing a spatiotemporal composite graph composed of the spatial graph and the temporal graph based on the features of each frame of the input video;
a spatiotemporal composite graph convolution module, for performing feature learning based on the spatiotemporal composite graph to obtain classification features; and
a classifier, for predicting an authenticity result of the to-be-detected face video based on the classification features.

The functionality of the encoder can be realized using existing mainstream convolutional neural networks or their optimized versions, such as ResNet, SCNet, Xception, etc. Its architecture is composed of a plurality of convolutional units and a plurality of downsampling units, where the convolutional units and the downsampling units are alternately connected in series.

A main body of the spatiotemporal composite graph is the temporal graph; the temporal graph takes the features of each frame of the input video as nodes, and takes a temporal sequence relationship as a basis for connection of the nodes; each node in the temporal graph corresponds to the spatial graph of the features of each frame of the image; and the spatial graph takes region features of a face component in one frame of the input video as nodes, and takes layout characteristics of the face component as the basis for connection of the nodes.

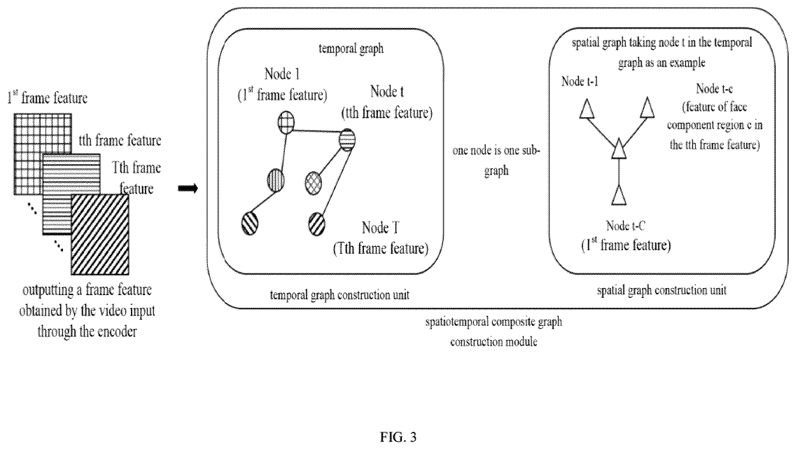

As show in FIG. 3, the spatiotemporal composite graph construction module comprises a temporal graph construction unit and a spatial graph construction unit; constructing the spatiotemporal composite graph based on the features of each frame of the image includes:
inputting f∈{T, c, h, w} into the spatiotemporal composite graph construction module, where f represents a feature vector obtained after being processed by an encoder, T represents a number of video frames, c represents a basic channel number of the features, h represents a feature height, and w represents a feature width;
the temporal graph construction unit obtains a feature vector fₜ∈{T, c×h×w} with the number T of video frames as a first dimension through a feature recombination method, and then obtains a temporal graph Gt, the temporal graph Gt contains the features of each frame corresponding to T nodes with a feature size c×h×w;
the spatial graph construction unit obtains a feature vector fₛ∈{T×h×w, c} with a total number of all positions T×h×w in each frame of the image as the first dimension through the feature recombination method, and then obtains a spatial graph Gs, the spatial graph Gs contains region features of h×w face components in each frame of the image corresponding to T×h×w nodes with a feature size c.

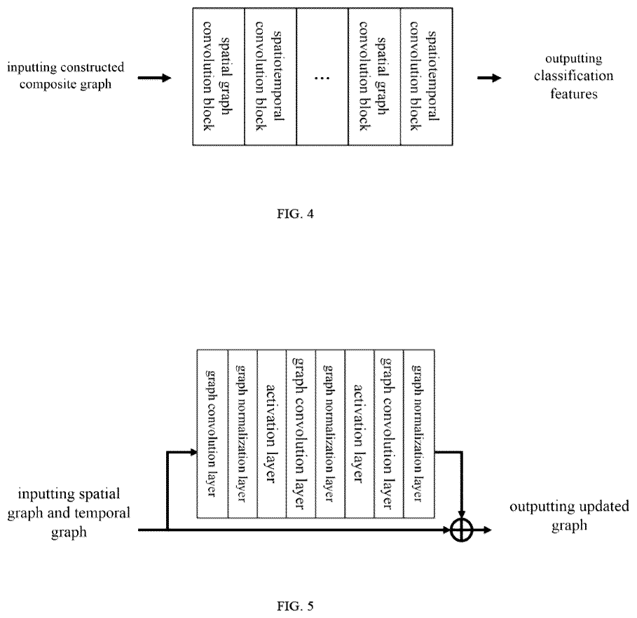

As shown FIG. 4, the spatiotemporal composite graph convolution module includes a plurality of spatial graph convolution blocks and a plurality of spatiotemporal convolution blocks, and the plurality of spatial graph convolution blocks and the plurality of spatiotemporal convolution blocks are alternately connected in series; and each spatial graph convolution block is configured to mine spatial features of an input spatial graph, and each spatiotemporal convolution block is configured to mine temporal features of an input temporal graph. In this embodiment, the spatiotemporal composite graph convolution module includes three spatial graph convolution blocks and three spatiotemporal convolution blocks.

As shown in FIG. 5, each of each spatial graph convolution block and each temporal graph convolution block include three graph convolution layers, three graph normalization layers and two activation layers, and three graph convolution layers, three graph normalization layers and two activation layers are alternately connected in series;
each graph convolution layer is configured to extract features from graph data by aggregating feature information of the nodes and neighbors of the nodes, capture a local structure and relationship information between the nodes in the graph, and provide a deep feature representation. A function formula adopted by each graph convolution layer is as follows:

$${H}^{l + 1} = ∅ ( {\tilde{D}}^{- \frac{1}{2}} \tilde{A} {\tilde{D}}^{- \frac{1}{2}} {H}^{l} {W}^{l} ) ;$$

where H^{l} and H^{l+1} represent node feature matrices of lth and l+1th layers, Ã represents a adjacency matrix of the graph, \tilde{D} represents a degree matrix of Ã, WI represents a learnable weight of the lth layer, and ∅ represents an activation function;
each graph normalization layer is configured to adjust a distribution of the data to a preset range, such that it makes the training of the model more stable and accelerates the convergence of the training process. A function formula adopted by each graph normalization layer is as follows:

$${\tilde{h}}_{i} = \frac{{h}_{i} - {µ}_{i}}{\sqrt{{σ}_{i}^{2} + ε}} ;$$

where \tilde{h}ᵢ represents a feature vector of a node i after normalization, hi represents a feature vector of the node i, μᵢ represents a mean value of all feature dimensions of the node i,

$${σ}_{i}^{2}$$

represents a variance of all feature dimensions of the node i, and ε represents a constant to avoid a denominator being zero.

The activation layer is configured to enhance a expressive ability of a model, and the activation function adopted by the activation layer includes a Rectified Linear Unit (ReLU).

The classifier comprises a fully connected layer, an input size of the fully connected layer is a size of the classification feature, and an output size of the fully connected layer is 2, which respectively represent a probability of the to-be-detected face video being authentic and forged.

A training method of the detection model includes:
Step A, obtaining a training set, where the training set comprises real face video data Vr and fake face video data Vf generated by deepfake technology, and a corresponding label y; where the label takes values of 0 and 1, 0 represents real samples, and 1 represents fake samples.

Specifically, obtaining the training set includes downloading a public dataset and constructing a private dataset;
the public dataset comprises FaceForensics++ (FF++) and DeepFake Detection Challenge (DFDC), etc.;
constructing the private dataset includes: obtaining face videos from video websites or collecting face videos; detecting faces using a Dlib tool from the face videos; aligning the faces using affine transformation; cropping face regions with a fixed margin set; and scaling cropped face images to a fixed pixel size; Scaling the cropped face image to a fixed pixel size. In this embodiment, both the length and width are set to 256 pixel values.
Step B, inputting the real face video data and the fake face video data generated by deepfake technology into the pre-constructed detection model to obtain a model prediction result;
Step C, calculating a cross-entropy loss function according to the model prediction result and the corresponding label; an expression of the cross-entropy loss function is as follows:

$$L ( y , \hat{y} ) = - ( y log \hat{y} + ( 1 - y ) log ( 1 - \hat{y} ) ) ;$$

where y represents the corresponding label, and y represents the model prediction result.
Step D, based on the Adam optimizer, for each training batch, using forward propagation to find the cross-entropy loss function, then using backpropagation to find partial derivatives of each weight parameter, and using a gradient descent method (such as Stochastic Gradient Descent (SGD)) to update the weight parameter, repeating this step until the cross-entropy loss function reaches a minimum to obtain the trained detection model.

### The Second Embodiment

Using the method described in the first Embodiment, the trained detection model is tested on the public test dataset Celeb-DF-v2, yielding an Area Under the ROC Curve (AUC) metric of 86.16%. This result significantly outperforms existing mainstream models, such as STIL (75.58%), TALL++-EffNetB4 (84.71%), and MRL (83.58%).

A metric of the area AUC surrounded by the ROC Curve obtained by testing on the public test dataset DFDC and the coordinate axes is 73.12%, which significantly exceeds existing methods: STIL (67.88%), TALL++-EffNetB4 (68.37%), and MRL (71.53%).

### The Third Embodiment

Building on the same inventive concept as the first embodiment, this example presents a face forgery detection system based on a graph convolutional neural network, which includes:
a data acquisition module, for obtaining a to-be-detected face video;
a detection module, for inputting the to-be-detected face video into a trained detection model to obtain a judgment result on whether the video is forged;
the detection model includes:
an encoder, for generating features of each frame of the to-be-detected face video;
a spatiotemporal composite graph construction module, for constructing a spatiotemporal composite graph composed of the spatial graph and the temporal graph based on the features of each frame of the image;
a spatiotemporal composite graph convolution module, for performing feature learning based on the spatiotemporal composite graph to obtain classification features; and
a classifier, for predicting an authenticity result of the to-be-detected face video based on the classification features.

The specific functional implementation of each of the above modules refers to the relevant content in the method of the first Embodiment, and will not be described in detail.

Those skilled in the art should understand that the embodiments of the present application can be provided as methods, systems, or computer program products. Therefore, the present application can take the form of a completely hardware embodiment, a completely software embodiment, or an embodiment combining software and hardware aspects. Moreover, the present application can take the form of a computer program product implemented on one or more computer-usable storage media (including but not limited to magnetic disk storage, CD-ROM, optical storage, etc.) containing computer-usable program code.

The present application is described with reference to the flowcharts and/or block diagrams of the methods, devices (systems), and computer program products according to the embodiments of the present application. It should be understood that each process and/or block in the flowcharts and/or block diagrams, as well as the combinations of processes and/or blocks in the flowcharts and/or block diagrams, can be implemented by computer program instructions. These computer program instructions can be provided to the processor of a general-purpose computer, a special-purpose computer, an embedded processor, or other programmable data processing device to generate a machine, so that the instructions executed by the processor of the computer or other programmable data processing device generate a device for implementing the functions specified in one or more processes of the flowchart and/or one or more blocks of the block diagram.

These computer program instructions can also be stored in a computer-readable memory that can guide a computer or other programmable data processing device to work in a specific way, so that the instructions stored in the computer-readable memory generate a manufactured product including an instruction device, and the instruction device implements the functions specified in one or more processes of the flowchart and/or one or more blocks of the block diagram.

These computer program instructions can also be loaded onto a computer or other programmable data processing device, so that a series of operation steps are executed on the computer or other programmable device to generate a computer-implemented processing, and the instructions executed on the computer or other programmable device provide the steps for implementing the functions specified in one or more processes of the flowchart and/or one or more blocks of the block diagram.

The above are only the preferred embodiments of the present application. It should be pointed out that for those skilled in the art, without departing from the technical principles of the present application, several improvements and modifications can be made, and these improvements and modifications should also be regarded as the protection scope of the present application.

What is claimed is:

1. A face forgery detection method based on a graph convolutional neural network, comprising:
obtaining a to-be-detected face video;
inputting the to-be-detected face video into a trained detection model to obtain a judgment result on whether the video is forged;
wherein the detection model comprises:
an encoder, for generating features of each frame of the to-be-detected face video;
a spatiotemporal composite graph construction module, for constructing a spatiotemporal composite graph composed of the spatial graph and the temporal graph based on the features of each frame of the image;
a spatiotemporal composite graph convolution module, for performing feature learning based on the spatiotemporal composite graph to obtain classification features; and
a classifier, for predicting an authenticity result of the to-be-detected face video based on the classification features.

2. The face forgery detection method based on the graph convolutional neural network according to claim 1, wherein a main body of the spatiotemporal composite graph is the temporal graph;
the temporal graph takes the features of each frame of the input video as nodes, and takes a temporal sequence relationship as a basis for connection of the nodes;
each node in the temporal graph corresponds to the spatial graph of the features of each frame of the input video; and
the spatial graph takes region features of a face component in one frame of the input video as nodes, and takes layout characteristics of the face component as the basis for connection of the nodes.

3. The face forgery detection method based on the graph convolutional neural network according to claim 1, wherein the spatiotemporal composite graph construction module comprises a temporal graph construction unit and a spatial graph construction unit;
constructing the spatiotemporal composite graph based on the features of each frame of the image comprises:
inputting ƒ∈{T, c, h, w} into the spatiotemporal composite graph construction module, where ƒ represents a feature vector obtained after being processed by an encoder, T represents a number of video frames, c represents a basic channel number of the features, h represents a feature height, and w represents a feature width;
the temporal graph construction unit obtains a feature vector ƒₜ∈{T, c×h×w} with the number T of video frames as a first dimension through a feature recombination method, and then obtains a temporal graph Gₜ, the temporal graph Gₜ contains the features of each frame corresponding to T nodes with a feature size c×h×w;
the spatial graph construction unit obtains a feature vector ƒₛ∈{T×h×w, c} with a total number of all positions T×h×w in each frame of the image as the first dimension through the feature recombination method, and then obtains a spatial graph Gₛ, the spatial graph Gₛ contains region features of h×w face components in each frame of the image corresponding to T×h×w nodes with a feature size c.

4. The face forgery detection method based on the graph convolutional neural network according to claim 1, wherein the spatiotemporal composite graph convolution module comprises a plurality of spatial graph convolution blocks and a plurality of spatiotemporal convolution blocks, and the plurality of spatial graph convolution blocks and the plurality of spatiotemporal convolution blocks are alternately connected in series; and
each spatial graph convolution block is configured to mine spatial features of an input spatial graph, and each spatiotemporal convolution block is configured to mine temporal features of an input temporal graph.

5. The face forgery detection method based on the graph convolutional neural network according to claim 4, wherein each of each spatial graph convolution block and each temporal graph convolution block comprise three graph convolution layers, three graph normalization layers and two activation layers, and three graph convolution layers, three graph normalization layers and two activation layers are alternately connected in series;
each graph convolution layer is configured to extract features from graph data by aggregating feature information of the nodes and neighbors of the nodes, capture a local structure and relationship information between the nodes in the graph, and provide a deep feature representation;
a function formula adopted by each graph convolution layer is as follows:
$${H}^{l + 1} = ∅ ( {\tilde{D}}^{- \frac{1}{2}} \tilde{A} {\tilde{D}}^{- \frac{1}{2}} {H}^{l} {W}^{l} ) ;$$
where H^{l} and H^{l+1} represent node feature matrices of lth and l+1th layers, Ã represents a adjacency matrix of the graph, \tilde{D} represents a degree matrix of Ã, W^{l} represents a learnable weight of the lth layer, and ∅ represents an activation function;
each graph normalization layer is configured to adjust a distribution of the data to a preset range, and a function formula adopted by each graph normalization layer is as follows:
$${\tilde{h}}_{i} = \frac{{h}_{i} - {µ}_{i}}{\sqrt{{σ}_{i}^{2} + ε}} ;$$
where \tilde{h}ᵢ represents a feature vector of a node i after normalization, hᵢ represents a feature vector of the node i, μᵢ represents a mean value of all feature dimensions of the node i,
$${σ}_{i}^{2}$$
represents a variance of all feature dimensions of the node i, and ε represents a constant to avoid a denominator being zero;
the activation layer is configured to enhance a expressive ability of a model, and the activation function adopted by the activation layer comprises a Rectified Linear Unit (ReLU).

6. The face forgery detection method based on the graph convolutional neural network according to claim 1, wherein the classifier comprises a fully connected layer, an input size of the fully connected layer is a size of the classification feature, and an output size of the fully connected layer is 2, which respectively represent a probability of the to-be-detected face video being authentic and forged.

7. The face forgery detection method based on the graph convolutional neural network according to claim 1, wherein a training method of the detection model comprises:
obtaining a training set, where the training set comprises real face video data and fake face video data generated by deepfake technology, and a corresponding label;
wherein the label takes values of 0 and 1, 0 represents real samples, and 1 represents fake samples;
inputting the real face video data and the fake face video data generated by deepfake technology into the pre-constructed detection model to obtain a model prediction result;
calculating a cross-entropy loss function according to the model prediction result and the corresponding label;
based on the Adam optimizer, for each training batch, using forward propagation to find the cross-entropy loss function, then using backpropagation to find partial derivatives of each weight parameter, and using a gradient descent method to update the weight parameter, repeating this step until the cross-entropy loss function reaches a minimum to obtain the trained detection model.

8. The face forgery detection method based on the graph convolutional neural network according to claim 7, wherein obtaining the training set comprises downloading a public dataset and constructing a private dataset;
the public dataset comprises FaceForensics++ and DeepFake Detection Challenge;
constructing the private dataset comprises:
obtaining face videos from video websites or collecting face videos;
detecting faces using a Dlib tool from the face videos;
aligning the faces using affine transformation;
cropping face regions with a fixed margin set; and
scaling cropped face images to a fixed pixel size.

9. The face forgery detection method based on the graph convolutional neural network according to claim 7, wherein an expression of the cross-entropy loss function is as follows:
$$L ( y , \hat{y} ) = - ( y log \hat{y} + ( 1 - y ) log ( 1 - \hat{y} ) ) ;$$
where y represents the corresponding label, and ŷ represents the model prediction result.
